(19) United States
(12) Patent Application Publication
(10) Pub. No.: US 2014/0333851 A1
(43) Pub. Date: Nov. 13, 2014

(54) TOUCH SCREEN PANEL AND METHOD FOR MANUFACTURING SAME

(71) Applicant: HON HAI PRECISION INDUSTRY CO., LTD., New Taipei (TW)

(72) Inventors: CHIN-YANG WU, New Taipei (TW); TEN-HSING JAW, New Taipei (TW); SZU-WEI SUNG, New Taipei (TW); CHIU-CHI CHEN, New Taipei (TW); WEN-KAI LO, New Taipei (TW)

(73) Assignee: HON HAI PRECISION INDUSTRY CO., LTD., New Taipei (TW)

(21) Appl. No.: 14/228,579

(22) Filed: Mar. 28, 2014

(30) Foreign Application Priority Data
May 13, 2013 (TW) 102116942

(51) Int. Cl. G06F 3/041

(52) U.S. Cl. CPC G06F 3/041
USPC 349/12; 29/622

(57) ABSTRACT

A touch screen panel includes a substrate, a plurality of driving electrodes formed over the substrate, a plurality of sensing electrodes arranged between the plurality of driving electrodes, a plurality of insulating layers, and a plurality of conducting connectors. Each of the plurality of insulating layers can be formed on each two neighboring sensing electrodes among the plurality of sensing electrodes and define two through holes. Each of the two through holes is positioned on corresponding one of the two neighboring sensing electrodes among the plurality of sensing electrodes. Each of the plurality of conducting connector formed on each of the plurality of insulating layers and filled the two through holes for electrically coupling with the two neighboring sensing electrodes among the plurality of sensing electrodes.

### FIELD

The present disclosure generally relates to a touch screen panel and a method for manufacturing the touch screen panel.

### BACKGROUND

Touch screen panels are an input device that, for example, allows manual instruction to be input by touching the screen. A typical touch screen panel includes a substrate, a plurality of sensing electrodes and a plurality of driving electrodes arranged among the plurality of sensing electrodes. The plurality of sensing electrodes and the plurality of driving electrodes are made of a transparent electrode material, such as indium tin oxide film (ITO). The driving electrodes are electrically coupled to each other in a first direction. The sensing electrodes are dispersed between the driving electrodes, do not overlap the driving electrodes and can be formed to have separated patterns along a second direction that intersects the first direction. A plurality of insulating layers is formed on the driving electrodes and the sensing electrodes. Each insulating layer is formed on each two neighboring sensing electrodes and overlaps portions of two driving electrodes positioned adjacent to the two neighboring sensing electrodes to provide an insulation property. A plurality of conducting connecters are formed and each conducting connecter is located on one insulating layer. Two ends of the conducting connecter protrude from the insulating layer and electrically couple the two neighboring sensing electrodes. Liner properties (thickness, length, width) of a conducting layer provide different conductivities of the conducting layer and affect properties of the touch screen panel. However, it is difficult to control liner properties (thickness, length, width) of a conducting layer in the manufacturing process.

### BRIEF DESCRIPTION OF THE DRAWING

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows an assembled, isometric view of a first embodiment of touch screen panel having a substrate, a plurality of driving electrodes, a plurality of sensing electrodes, a plurality of insulating layers, and a plurality of conducting connectors.

FIG. 2 shows a partially enlarged view of the plurality of driving electrodes and the plurality of sensing electrodes on the substrate.

FIG. 3 shows a partially enlarged view of the plurality of insulating layers on the plurality of driving electrodes and the plurality of sensing electrodes.

FIG. 4 shows a partial and enlarged view of the plurality of conducting connectors on the plurality of insulating layers of area II of the FIG. 1.

FIG. 5 shows a flowchart for manufacturing the touch screen panel of FIG. 1.

FIG. 6 shows a partial and enlarged view of an insulting layer on a substrate of a second embodiment of another touch screen panel.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

The term “coupled” is defined as connected, whether directly or indirectly through intervening components, and is not necessarily limited to physical connections. The connection can be such that the objects are permanently connected or releasably connected.

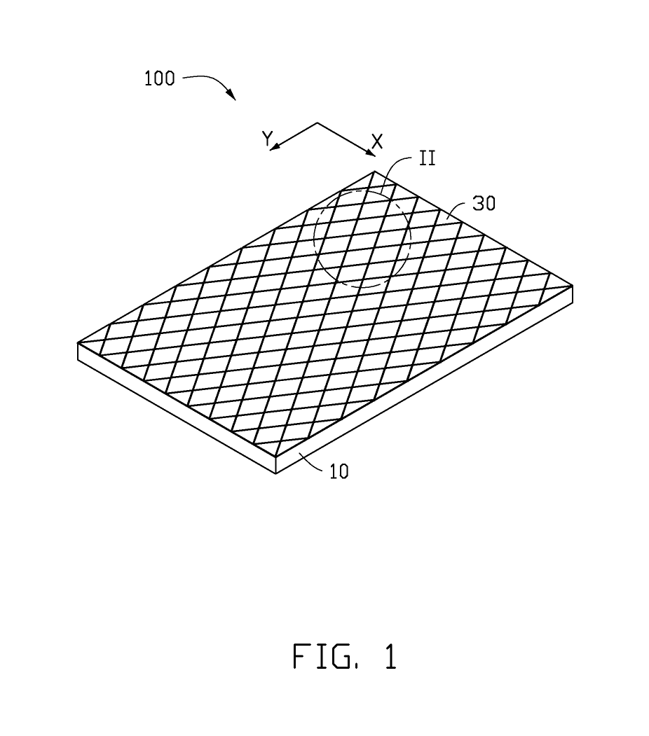

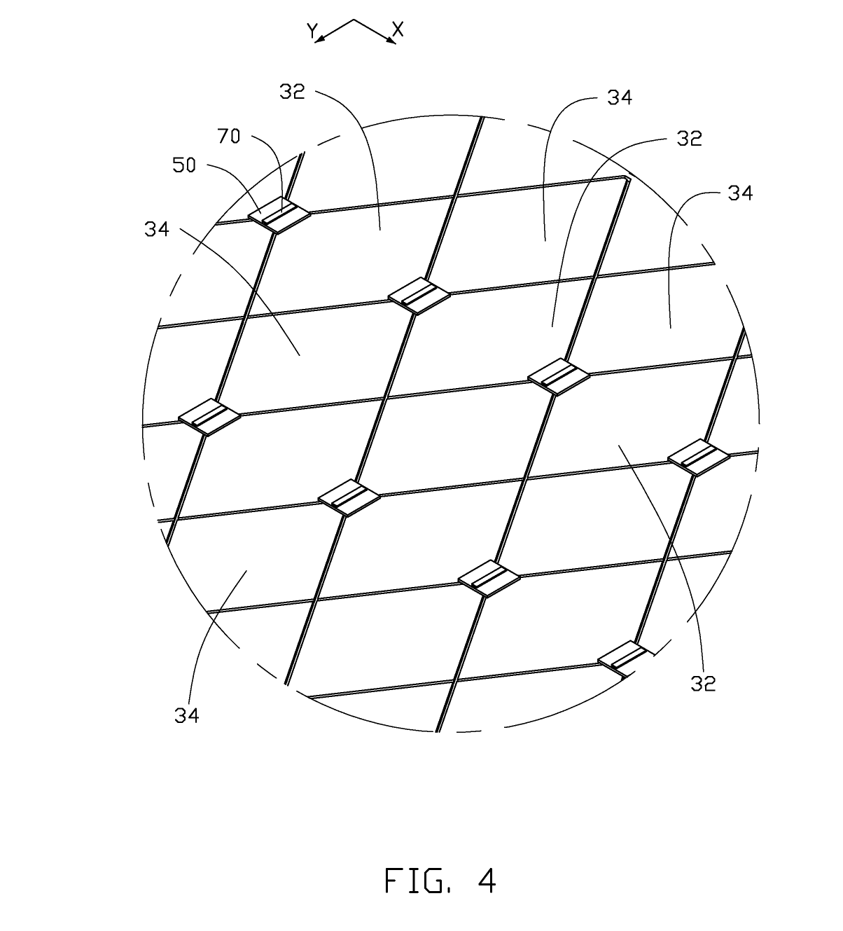

FIGS. 1 and 4 show a touch screen panel 100 of a first embodiment including a substrate 10, a plurality of driving electrodes 32, and a plurality of sensing electrodes 34 arranged between the plurality of driving electrodes 32. The driving electrodes 32 and the sensing electrodes 34 can be formed in mesh structures on the substrate 10. The driving electrodes 32 can be electrically coupled each other in a first direction X. The sensing electrodes 34 can be arranged between the driving electrodes 32 to have separated patterns along a second direction Y that intersects the first direction X, thereby the sensing electrodes 34 not to overlap the driving electrodes 32.

The driving electrodes 32 and the sensing electrodes 34 can be formed of a transparent electrode material, such as indium tin oxide film (ITO), indium-zinc oxide (IZO), zinc oxide (ZnO), carbon nano-tubes (CNT), a conductive polymer, or graphene which can be transparent and has electric conductivity on the substrate 10. The substrate 10 can be made of transparent insulation material, such as polyethylene terephthalate (PET), polyimide (PI), or polycarbonate (PC) for example. The plurality of sensing electrodes 34 and the plurality of driving electrode 32 can be formed wherein a transparent electrode material layer 30 is etched on the substrate 10.

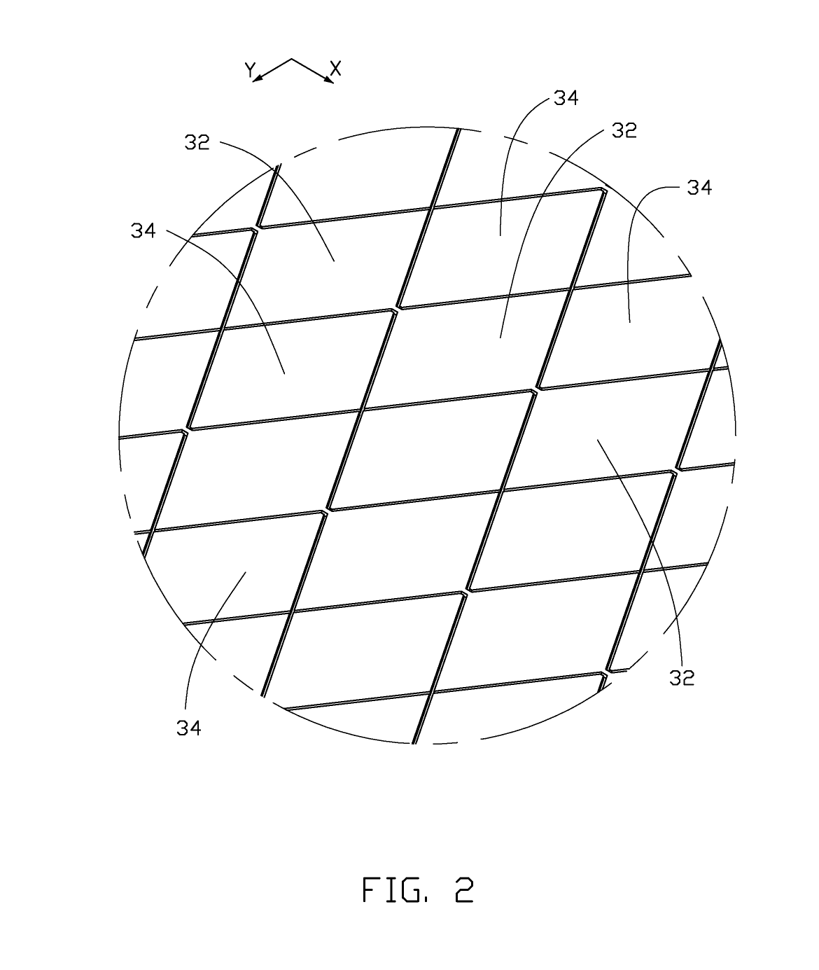

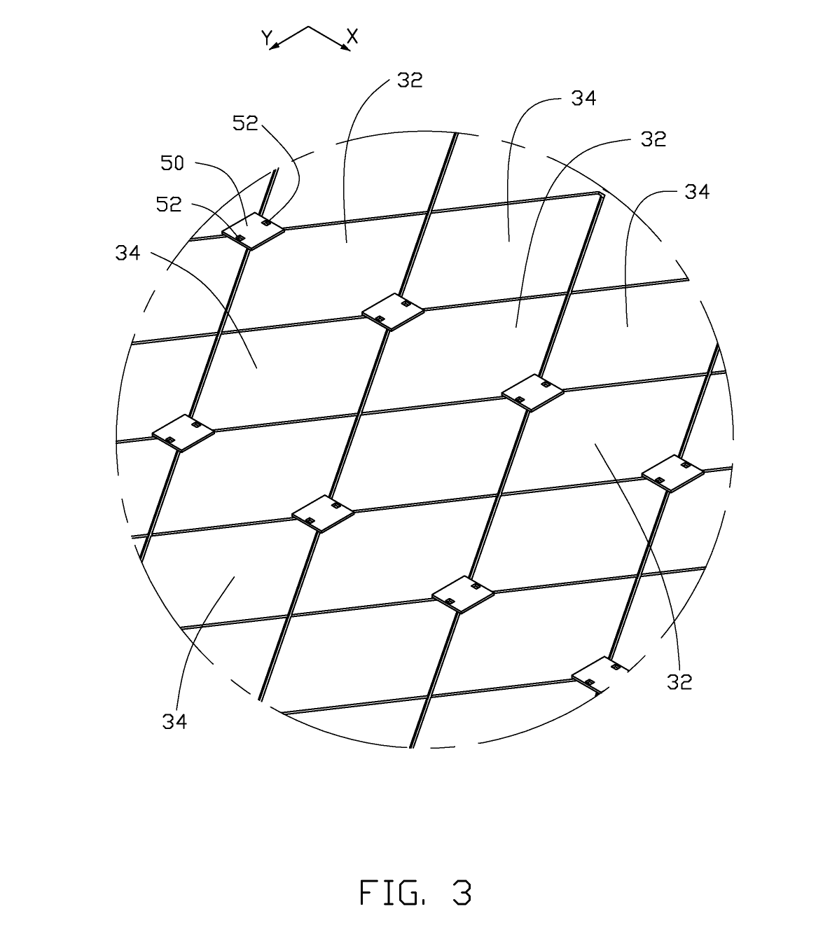

FIGS. 2-4 show a plurality of insulating layers 50 patterned on the plurality of driving electrodes 32 and the plurality of sensing electrodes 34. Each insulating layer 50 can overlap two neighboring sensing electrodes 34 of the same row along the second direction Y to provide an insulation property. Each insulating layer 50 can overlap a portion of each of two driving electrodes 32, which can be positioned adjacent to the two neighboring sensing electrodes 34. Each insulating layer 50 can be substantially rectangular-shaped. A thickness of each insulating layer 50 can be about 1 μm to 3 μm. Each insulating layer 50 can cover a portion of each of the two neighboring sensing electrodes 34. In other embodiments, the insulating layer 50 can be in other shapes, such as a triangle, a hexagon, or circle. A width of each insulating layer 50 can be about 100 μm to 300 μm, and a length of each insulating layer 50 can be about 300 μm to 600 μm. Two substantial circular-shaped through holes 52 can be formed in each insulating layer 50, and each through hole 52 can be positioned on a corresponding sensing electrode 34. A hole diameter of the through hole 52 can be about 50 μm to 150 μm.

A plurality of conducting connectors 70 can be formed on the plurality of insulating layers 50. Each conducting connector 70 can be formed on one insulating layer 50 and can electrically contact the corresponding two neighboring sensing electrodes 34 via the two through holes 52 of each insulating layer 50. Thereby, the sensing electrodes 34 arranged in the same row along the second direction Y can be electrically coupled to each other. A thickness of the conducting connector 70 can be about 0.1 μm to 1 μm. A width of the conducting connector 70 can be substantially equal to or greater than the diameter of the through hole 52. In the illustrated embodiment, the conducting connector 70 and the insulating layer 50 can be formed via an ink jet printing method. The insulating layers 50 are made of thermosetting, UV-type and transparent organic materials, such as polyimide (PI). The conducting connector 70 is made of one from the group including graphene, silver nanowire, carbon nanotube, and highly conductive polymer. In other embodiments, the through holes 52 can be in other shapes, such as circular, rectangular, and the number of the through holes 52 can be three or more.

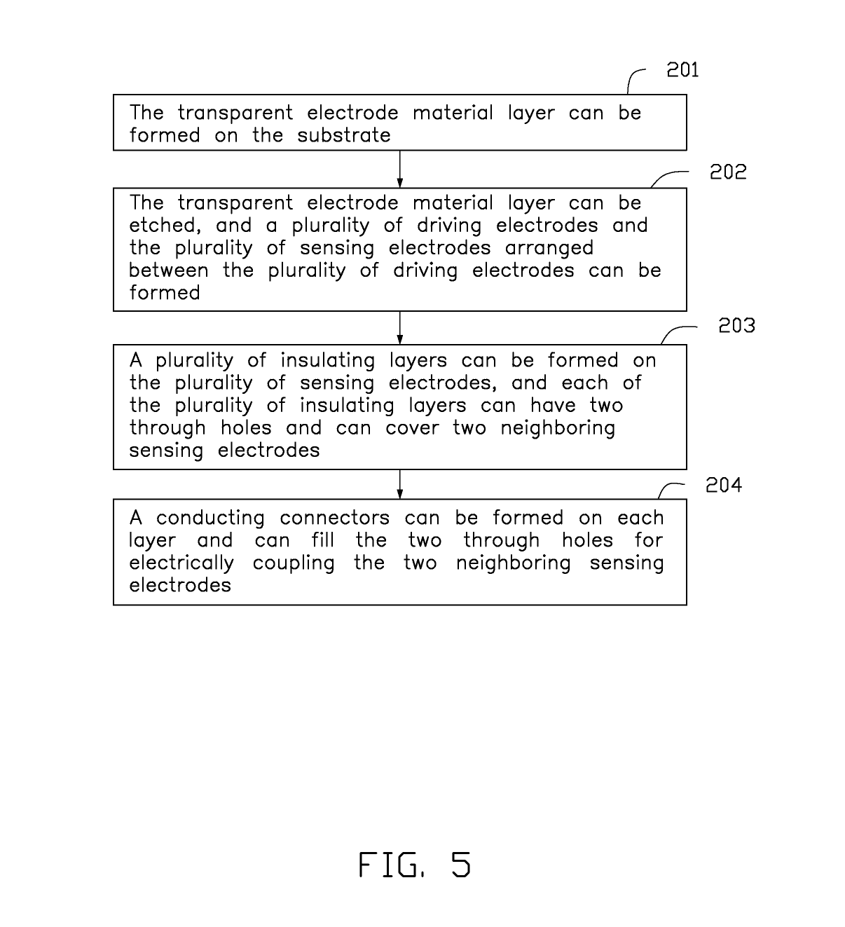

FIG. 5 shows an illustrated embodiment of the method for manufacturing the touch screen panel.

In 201, the transparent electrode material layer can be formed on the substrate. In the illustrated embodiment, the transparent electrode material layer is made of a material, such as indium tin oxide film (ITO), indium-zinc oxide (IZO), zinc oxide (ZnO), carbon nanotubes (CNT), a conductive polymer, or graphene which is transparent and has electric conductivity on the substrate. The substrate can be made of transparent insulation material, such as polyethylene terephthalate (PET), polyimide (PI), or polycarbonate (PC), for example. The transparent electrode material layer can be coated on the substrate by a sputtering coating method.

In 202, the plurality of driving electrodes and the plurality of sensing electrodes can be formed via etching the transparent electrode material layer. The driving electrodes and the sensing electrodes can be formed in mesh structures on the substrate. The driving electrodes can be electrically coupled to each other along the first direction X. The sensing electrodes can be dispersed between the driving electrodes not overlapping the driving electrodes and can be formed to have separated patterns along the second direction Y. Thereby, the sensing electrodes can be insulated from each other. In present embodiment, the transparent electrode material layer can be etched via a chemical etching method, the driving electrodes in the same row along the first direction X can be electrically connected with each other, and the driving electrodes in the same row along the second direction Y can be insulated from each other.

In 203, The plurality of insulating layers, each having two through holes, can be patterned on the plurality of driving electrodes and the plurality of sensing electrodes via ink jet printing. Each insulating layer can be located on at least two neighboring sensing electrodes along the second direction Y, and each through hole can be located above corresponding sensing electrode. In the illustrated embodiment, the insulating layers can be formed via an ink jet printing method. The thickness of the conducting connector can be about 0.1 μm to 1 μm. The insulating layer can be substantially rectangular-shaped. In other embodiments, the insulating layer can be in other shapes, such as a triangle, a hexagon, or circle. The width of each insulating layer can be about 100 μm to 300 μm, and the length of each insulating layer can be about 300 μm to 600 μm. The diameter of the through hole can be about 50 μm to 150 μm.

In 204, referring to FIG. 4, the conducting connector can be formed on each insulating layer via the ink jet printing method and fills the two through holes of each insulating layer 50 for electrically coupling with the two neighboring sensing electrodes. In the illustrated embodiment, the thickness of the conducting connector is about 0.1 μm to 1 μm. The width of the conducting connector can be substantially equal to or greater than the diameter of the through hole.

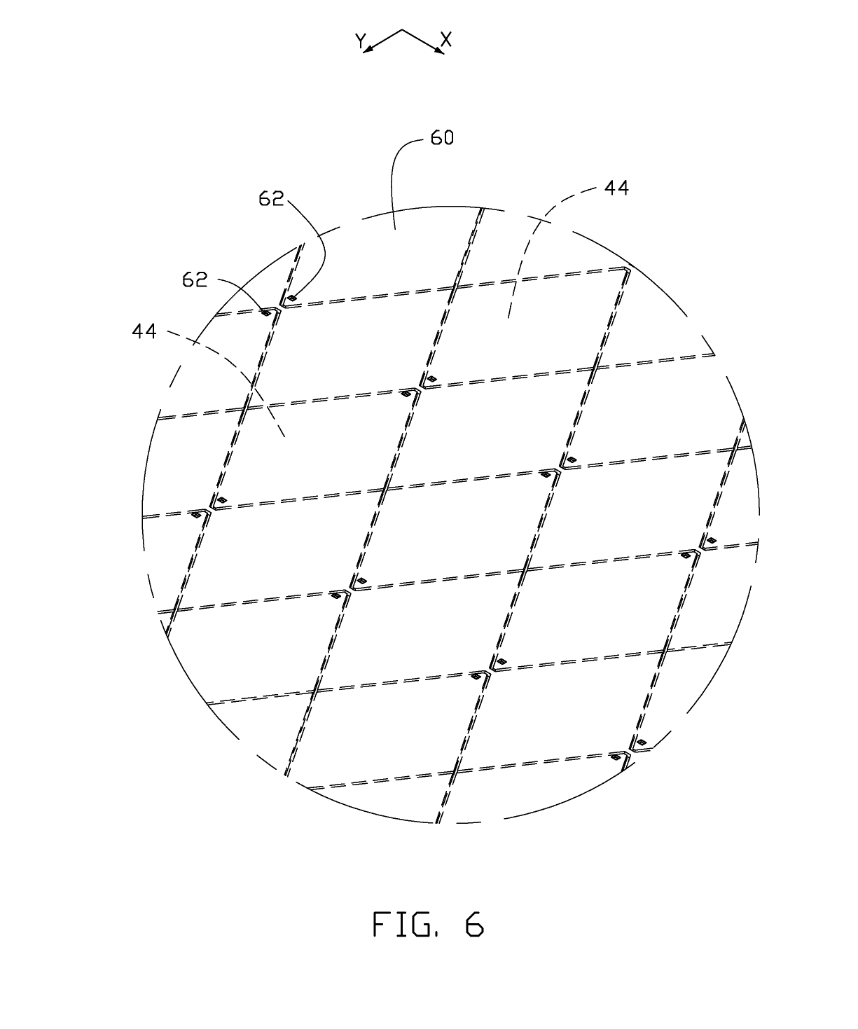

FIG. 6 shows that a touch screen panel 300 of a second embodiment, which is similar to the touch screen panel 100 of the first embodiment. The difference can be just one insulating layer 60 formed on the entirety of sensing electrodes 44 and the driving electrodes 42. In other words, the insulating layer 60 can cover the total another sensing electrodes 44 and the driving electrodes 42. A plurality of through holes 62 can be formed in the insulating layer 60, and each another two neighboring through holes 62 can correspond to two neighboring sensing electrodes 44 arranged along the second direction Y. A plurality of conducting connector (not shown) can be formed. Each another conducting connector (not shown) can fill the two neighboring through holes 62 for electrically connecting with the two neighboring sensing electrodes 44.

As described above, through holes can be defined in the in insulating layer and each through hole can be positioned above a corresponding sensing electrode, the conducting connector can fill the through holes for electrically connecting with the two neighboring sensing electrodes. Shapes and sizes of the through holes can be the same, thereby liner properties of the conducting connectors can be easily controlled accurately in a filling process. The conductive properties of the conducting connectors having same liner properties and shapes, and improved touch properties.

While the present disclosure has been described with reference to particular embodiments, the description is illustrative of the disclosure and is not to be construed as limiting the disclosure. Therefore, those of ordinary skill in the art can make various modifications to the embodiments without departing from the true spirit and scope of the disclosure, as defined by the appended claims.

What is claimed is:

1. A touch screen panel comprising:
a substrate;
a plurality of driving electrodes formed over the substrate;
a plurality of sensing electrodes arranged between the plurality of driving electrodes;
a plurality of insulating layers, each of the plurality of insulating layers formed on two neighboring sensing electrodes among the plurality of sensing electrodes and each defining two through holes, wherein each of the two through holes is positioned on a corresponding one of the two neighboring sensing electrodes among the plurality of sensing electrodes; and
a plurality of conducting connectors, each of the plurality of conducting connectors formed on each of the plurality of insulating layers and contacting electrically the two neighboring sensing electrodes among the plurality of sensing electrodes via the two through holes.

2. The touch screen panel of claim 1, wherein the plurality of driving electrodes and the plurality of sensing electrodes are made of one from the group including of a transparent electrode material.

3. The touch screen panel of claim 1, wherein plurality of insulating layers is made of thermosetting, UV-type and transparent organic materials.

4. The touch screen panel of claim 1, wherein a thickness of each of the plurality of insulating layers is about 1 μm to 3 μm.

5. The touch screen panel of claim 1, wherein a width of each of the plurality of insulating layers is about 100 μm to 300 μm.

6. The touch screen panel of claim 1, wherein a length of each of the plurality of insulating layers is about 300 μm to 600 μm.

7. The touch screen panel of claim 1, wherein a diameter of each through hole is about 50 μm to 150 μm.

8. The touch screen panel of claim 1, wherein a thickness of each of the plurality of conducting connectors is about 0.1 μm to 1 μm.

9. The touch screen panel of claim 1, wherein each of the plurality of conducting connectors are made of one from the group including graphene, silver nanowire, carbon nano tube, and highly conductive polymer.

10. A touch screen panel comprising:
a substrate;
a plurality of driving electrodes formed over the substrate;
a plurality of sensing electrodes arranged between the plurality of driving electrodes;
a insulating layer formed on the plurality of sensing electrodes and defining two through holes, wherein a plurality of through holes are formed on the insulating layer, each of the two through holes among the plurality of through holes is positioned on a corresponding one of the two neighboring sensing electrodes among the plurality of sensing electrodes; and
a plurality of conducting connectors, each of the plurality of conducting connector formed on the insulating layer and contacting electrically the two neighboring sensing electrodes among the plurality of sensing electrodes via the two through holes among the plurality of through holes

11. The touch screen panel of claim 10, wherein the insulating layer is made of thermosetting, UV-type and transparent organic materials.

12. The touch screen panel of claim 10, wherein a thickness of the insulating layer is about 1 μm to 3 μm.

13. The touch screen panel of claim 10, wherein a width of the insulating layer is about 100 μm to 300 μm.

14. The touch screen panel of claim 10, wherein a length of the insulating layer is about 300 μm to 600 μm.

15. The touch screen panel of claim 10, wherein a diameter of each through hole is about 50 μm to 150 μm.

16. The touch screen panel of claim 10, wherein a thickness of the conducting connector is about 0.1 μm to 1 μm.

17. The touch screen panel of claim 10, wherein the plurality of conducting connectors is made of one from the group including grapheme, silver nano wire, carbon nano tube, and highly conductive polymer.

18. A method of manufacturing a touch screen panel, comprising:
forming a transparent electrode material layer on a substrate;
etching the transparent electrode material layer and forming a plurality of driving electrodes and the plurality of sensing electrodes arranged between the plurality of driving electrodes;
forming a plurality of insulating layers on the plurality of sensing electrodes, each of the plurality of insulating layers having two through holes and covering two neighboring sensing electrodes among the plurality of sensing electrodes, and each of the two through holes positioned on corresponding one of the two neighboring sensing electrodes among the plurality of sensing electrodes; and
forming a conducting connectors on each of the plurality of insulating layers and the conducting connector filling the two through holes for electrically coupling the two neighboring sensing electrodes among the plurality of sensing electrodes.

19. The manufacturing method of claim 18, wherein the plurality of conducting connectors are formed on the each of the plurality of insulating layers via an ink jet printing method.

20. The manufacturing method of claim 18, wherein the plurality of insulating layers are formed on the plurality of sensing electrodes via an ink jet printing method.
